(19) United States
(12) Patent Application Publication
(10) Pub. No.: US 2019/0394255 A1
(43) Pub. Date: Dec. 26, 2019

(54) INTERMEDIATED RETRIEVAL OF NETWORKED CONTENT

(71) Applicant: Citrix Systems, Inc., Fort Lauderdale, FL (US)

(72) Inventor: Yuri Kolesnikov, Raleigh, NC (US)

(21) Appl. No.: 16/016,848

(22) Filed: Jun. 25, 2018

(51) Int. Cl. H04L 29/08; G06F 17/30

(52) U.S. Cl. CPC H04L 67/02; H04L 67/28; G06F 17/30899

(57) ABSTRACT

Methods, systems, computer-readable media, and apparatuses may provide, via a remote computing device, tabbed web browsing to a client computing device. A remote computing device may comprise a plurality of sessions. A session may include an instance of a web browser executable. The client computing device may display output corresponding to the web browser executable in a display application. The remote computing device may receive, from the client computing device and via an application different than the display application, an indication of a new web page. The remote computing device may cause the web browser to display the new web page in a new tab in the web browser executable.

### FIELD

Aspects of the disclosure relate to computer hardware and/or software. In particular, one or more aspects of the disclosure generally relate to computer hardware and software for retrieving and accessing content such as web pages over a wide area network.

### BACKGROUND

When browsing the Internet, users frequently access a large number of web pages. Multiple web pages opened at the same time may be depicted as various tabs in the same instance of a web browser executable. Using these tabs, a user may switch a display from one currently-open web page to another currently-open web page without needing to close the former website.

Users frequently use virtual web browsing sessions on remote servers to browse web pages. A remote server may execute a web browsing application the same or similar to that which may be run on a client computing device. The remote server may send a video and audio feed of the web browsing application to a computing device and receive input commands from a user via the computing device. A user may thereby, on a client computing device and via the remote server, browse web pages in a similar manner to how they may browse web pages directly on the client computing device. This may provide a faster and more secure browsing service for the user: for example, private content such as authentication credentials may be retained on a secure remote server, rather than on a relatively insecure client computing device. But the remote nature of a remote server also makes it difficult to, for example, browse a large number of websites at once. In many remote server implementations, different web pages may be opened in different sessions on the remote server, which may be computationally wasteful and may be difficult for the user to manage.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects of the disclosure provide a method of receiving and handling multiple web browser tabs in a remote web browsing session.

A remote computing device may provide, to a client computing device, a session. The remote computing device may, using the session, execute a web browser program, receive input from the client computing device over a network, and/or provide output corresponding to the web browser program to the client computing device over the network. The remote computing device may be configured to receive an instruction to open a new web page. The instruction may be from the client computing device, another session of the remote computing device, or another computing device, such as a proxy. The instruction may indicate that the new web page is to be opened in a new tab in the web browser program and/or a new session on the remote computing device. The instruction may be received by a helper application executing on the remote computing device, which may determine a session corresponding to the instruction. The remote computing device may be configured to, based on the instruction, open the new web page in the web browser program in the session.

The details of these and other features are set forth in the accompanying drawings and the description below. Other features and advantages will be apparent from the description, drawings, and from the claims.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying drawings in which like numerals indicate similar elements.

FIG. 1 shows an illustrative computer system architecture that may be used in accordance with one or more illustrative aspects described herein.

FIG. 2 shows an illustrative remote-access system architecture that may be used in accordance with one or more illustrative aspects described herein.

FIG. 3 shows an example virtualized (hypervisor) system architecture that may be used in accordance with one or more illustrative aspects described herein.

FIG. 4 shows an example block diagram comprising a remote computing device and client computing devices.

FIG. 5 is a flow chart which may be performed by a remote computing device.

FIG. 6 shows an example menu application which may be executed by a client computing device.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

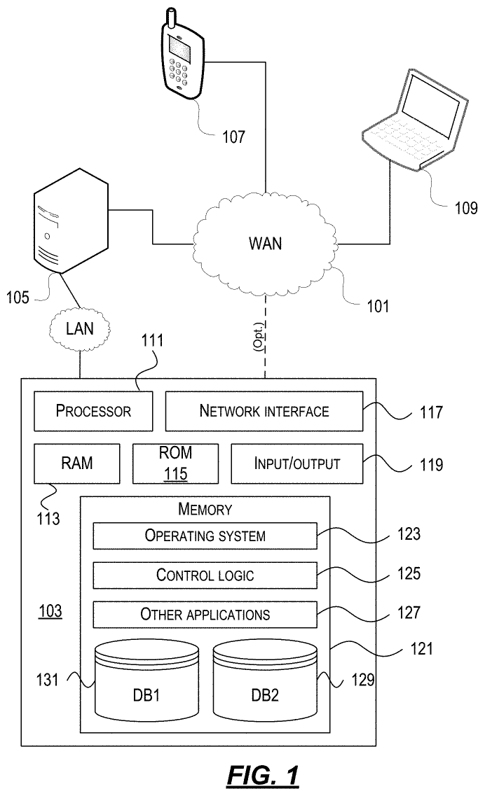

FIG. 1 illustrates one example of a system architecture and data processing device that may be used to implement one or more illustrative aspects described herein in a standalone and/or networked environment. Computer software, hardware, and networks may be utilized in a variety of different system environments, including standalone, networked, remote-access (also known as remote desktop), virtualized, and/or cloud-based environments, among others. Devices including the data server 103, web server 105, and client computers 107 may be interconnected via a wide area network (WAN) 101, such as the Internet. Other networks may also or alternatively be used, including private intranets, corporate networks, local area networks (LAN), metropolitan area networks (MAN), wireless networks, personal area networks (PAN), and the like. The WAN 101 is for illustration purposes and may be replaced with fewer or additional computer networks. A local area network 143 may have one or more of any known LAN topology and may use one or more of a variety of different protocols, such as Ethernet. Devices including the data server 103, web server 105, and client computers 107 may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include a data server 103, a web server 105, and client computers 107, 109. The data server 103 may provide overall access, control and administration of databases and control software for performing one or more illustrative aspects describe herein. The data server 103 may be connected to the web server 105, through which users may interact with and obtain data as requested. Additionally or alternatively, the data server 103 may act as a web server itself and be directly connected to the Internet. The data server 103 may be connected to the web server 105 through the local area network 143, the WAN 101 (e.g., the Internet), via direct or indirect connection, or via some other network. Users may interact with the data server 103 using client computers 107, 109, e.g., using a web browser to connect to the data server 103 via one or more externally exposed web sites hosted by the web server 105. The client computers 107, 109 may be used in concert with the data server 103 to access data stored therein, or may be used for other purposes. For example, a user may access, via the client computing device 107, the web server 105 using an Internet browser, as is known in the art, or by executing a software application that communicates with the web server 105 and/or the data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by the web server 105 and the data server 103 may be combined on a single server.

Each of the data server 103, web server 105, and client computers 107, 109 may be any type of known computer, server, or data processing device. The data server 103, e.g., may include a processor 111 controlling overall operation of the data server 103. The data server 103 may further include a random access memory (RAM) 113, a read only memory (ROM) 115, a network interface 117, input/output interfaces 119 (e.g., keyboard, mouse, display, printer, etc.), and a memory 121. The input/output (I/O) 119 may include a variety of interface units and drives for reading, writing, displaying, and/or printing data or files. The memory 121 may further store operating system software 123 for controlling overall operation of the data server 103, control logic 125 for instructing the data server 103 to perform aspects described herein, and other application software 127 providing secondary, support, and/or other functionality which may or might not be used in conjunction with aspects described herein. The control logic 125 may also be referred to herein as the data server software. Functionality of the data server software may refer to operations or decisions made automatically based on rules coded into the control logic, made manually by a user providing input into the system, and/or a combination of automatic processing based on user input (e.g., queries, data updates, etc.).

The memory 121 may also store data used in performance of one or more aspects described herein, including a first database 129 and a second database 141. The first database may include the second database (e.g., as a separate table, report, etc.). That is, the information can be stored in a single database, or separated into different logical, virtual, or physical databases, depending on system design. The data server 103, web server 105, and/or the client computers 107, 109 may have similar or different architecture as described with respect to the data server 103. Those of skill in the art will appreciate that the functionality of the data server 103 (or devices 105, 107, and/or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, compact disks, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

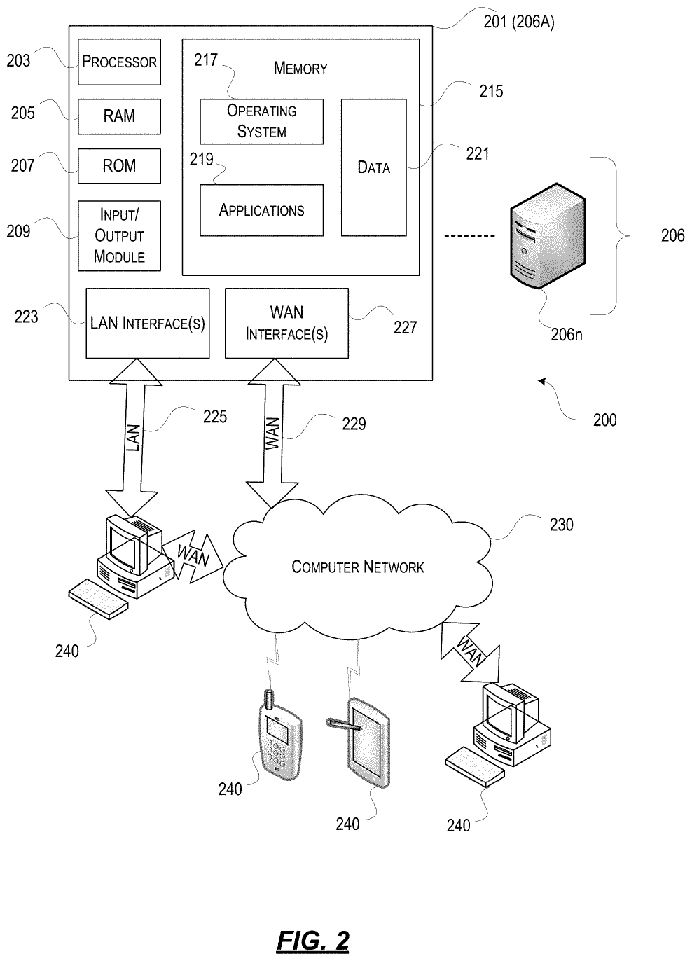

With further reference to FIG. 2, one or more aspects described herein may be implemented in a remote-access environment. FIG. 2 depicts an illustrative system architecture including a computing device 201 in a computing environment 200 that may be used according to one or more illustrative aspects described herein. A computing device 201 may be used as a server (e.g., first server 206a) in a single-server or multi-server desktop virtualization system (e.g., a remote access or cloud system) configured to provide virtual machines for client access devices. The computing device 201 may have a processor 203 for controlling overall operation of the server and its associated components, including RAM 205, ROM 207, Input/Output (I/O) module 209, and a memory 215.

The I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within the memory 215 and/or other storage to provide instructions to the processor 203 for configuring the computing device 201 into a special purpose computing device in order to perform various functions as described herein. For example, the memory 215 may store software used by the computing device 201, such as an operating system 217, application programs 219, and an associated database 221.

The computing device 201 may operate in a networked environment supporting connections to one or more remote computers, such as terminals 240 (also referred to as client computing devices). The terminals 240 may be personal computers, mobile devices, laptop computers, tablets, or servers that include many or all of the elements described above. The network connections depicted in FIG. 2 include a local area network (LAN) 225 and a wide area network (WAN) 229, but may also include other networks. When used in a LAN networking environment, the computing device 201 may be connected to the LAN 225 through a network interface or an adapter 223. When used in a WAN networking environment, the computing device 201 may include a modem 227 or other wide area network interface for establishing communications over the WAN 229, such as a computer network 230 (e.g., the Internet). It will be appreciated that the network connections shown are illustrative and other means of establishing a communications link between the computers may be used. The computing device 201 and/or the terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers, minicomputers, mainframe computers, distributed computing environments that include any of the above systems or devices, and the like.

As shown in FIG. 2, one or more client computing devices 240 may be in communication with one or more servers 206a-206n (generally referred to herein as “server(s) 206”). In one embodiment, the computing environment 200 may include a network appliance installed between the server(s) 206 and client computing devices 240. The network appliance may manage client/server connections, and in some cases can load balance client connections amongst a plurality of servers 206.

The client computing devices 240 may be referred to as a single client computing device 240 or a single group of client computing devices 240, while server(s) 206 may be referred to as a single server 206 or a single group of servers 206. In one embodiment a single client computing device 240 communicates with more than one server 206, while in another embodiment a single server 206 communicates with more than one client computing device 240. In yet another embodiment, a single client computing device 240 communicates with a single server 206.

A client computing device 240 may be referenced by any one of the following non-exhaustive terms: client machine(s); client(s); client computer(s); client computing device(s); client computing device(s); local machine(s); remote machine(s); client node(s); endpoint(s); and/or endpoint node(s). The server 206 may be referenced by any one of the following non-exhaustive terms: server(s); remote computing device(s); local machine(s); remote machine(s); server farm(s); and/or host computing device(s).

In one embodiment, the client computing device 240 may be a virtual machine. The virtual machine may be any virtual machine, while the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client computing device 240.

A client computing device 240 may display application output generated by an application remotely executing on a server 206 or other remotely located machine. The client computing device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206 may use a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm, for example, in a cloud computing environment. The server farm may include servers 206 that are geographically dispersed while and logically grouped together, or servers 206 that are located proximate to each other while logically grouped together. Geographically dispersed servers 206a-206n within the server farm may communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. The server farm may be administered as a single entity and/or may include multiple server farms.

A server farm may include servers 206 that execute a similar type of operating system platform (e.g., WINDOWS, UNIX, LINUX, iOS, ANDROID, SYMBIAN, etc.) The server farm may include a first group of one or more servers that execute a first type of operating system platform, and a second group of one or more servers that execute a second type of operating system platform.

A server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

A first server 206a may receive requests from the client computing device 240, forward the request to a second server 206b (not shown), and respond to the request generated by the client computing device 240 with a response from the second server 206b (not shown). The first server 206a may acquire an enumeration of applications available to the client computing device 240 and well as address information associated with a server 206 hosting an application identified within the enumeration of applications. The first server 206a can then present a response to the client's request using a web interface, and communicate directly with the client computing device 240 to provide the client computing device 240 with access to an identified application. One or more client computing devices 240 and/or one or more servers 206 may transmit data over the computer network 230, e.g., the WAN 101.

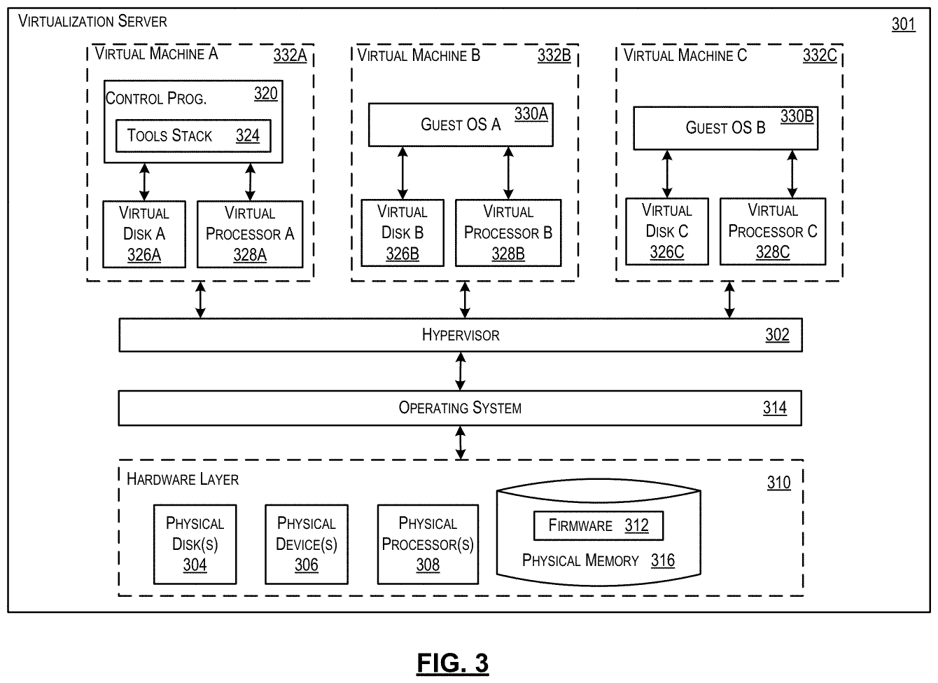

FIG. 3 shows a high-level architecture of an illustrative desktop virtualization system. A desktop virtualization system may be single-server or multi-server system, or cloud system, including one or more virtualization servers 301 configured to provide virtual desktops and/or virtual applications to one or more client computing devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A virtualization server 301 may be a computing device in a virtualization environment, for example, a single-server, multi-server, or cloud computing environment. The virtualization server 301 illustrated in FIG. 3 can be deployed as and/or implemented by the server 206 illustrated in FIG. 2 and/or by other known computing devices. Included in the virtualization server 301 is a hardware layer that can include one or more physical disks 304, one or more physical devices 306, one or more physical processors 308, and one or more physical memories 316. Firmware 312 may be stored within a memory element in the physical memory 316 and may be executed by one or more of the physical processors 308. The virtualization server 301 may further include an operating system 314 that may be stored in a memory element in the physical memory 316 and executed by one or more of the physical processors 308. A hypervisor 302 may be stored in a memory element in the physical memory 316 and can be executed by one or more of the physical processors 308.

Executing on one or more of the physical processors 308 may be one or more virtual machines 332A-C (generally, 332). Each virtual machine 332 may have a virtual disk 326A-C and/or a virtual processor 328A-C. For example, a first virtual machine 332A may execute, using a virtual processor 328A, a control program 320 that includes a tools stack 324. The control program 320 may be referred to as a control virtual machine, Dom0, Domain 0, or other virtual machine used for system administration and/or control. One or more virtual machines 332B-C may execute, using a virtual processor 328B-C, operating system 330A-B (also known as guest operating systems).

The virtualization server 301 may include a hardware layer 310 with one or more pieces of hardware that communicate with the virtualization server 301. The hardware layer 310 may include one or more physical disks 304, one or more physical devices 306, one or more physical processors 308, and one or more physical memory 316. Physical components, e.g., the one or more physical disks 304, the one or more physical devices 306, the one or more physical processors 308, and/or the one or more physical memory 316, may include, for example, any of the components described above. The physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. The physical memory 316 in the hardware layer 310 may include any type of memory. The physical memory 316 may store data, and may store one or more programs, or set of executable instructions. The firmware 312 may be stored within the physical memory 316 of virtualization server 301. Programs or executable instructions stored in the physical memory 316 can be executed by the one or more processors of the virtualization server 301.

The virtualization server 301 may also include a hypervisor 302. The hypervisor 302 may be a program executed by the physical processors 308 on virtualization server 301 to create and manage any number of virtual machines 332. Hypervisor 302 may be referred to as a virtual machine monitor, or platform virtualization software. The hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor. The Type 2 hypervisor may execute within the context of a user's operating system such that the Type 2 hypervisor interacts with the user's operating system. Additionally or alternatively, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a operating system 314, as shown, a Type 1 hypervisor may directly access all system resources without the operating system 314. A Type 1 hypervisor may execute directly on one or more physical processors 308 of virtualization server 301, and may include program data stored in the physical memory 316.

The hypervisor 302 may provide virtual resources to operating systems 330 or control programs 320 executing on the virtual machines 332 in any manner that simulates the operating systems 330 or the control programs 320 having direct access to system resources. System resources may include, but are not limited to, the physical devices 306, the physical disks 304, the physical processors 308, physical memory 316, and any other component included in the virtualization server 301 and/or the hardware layer 310. The hypervisor 302 may be used to emulate virtual hardware, partition physical hardware, virtualize physical hardware, and/or execute virtual machines that provide access to computing environments. Additionally or alternatively, the hypervisor 302 may control processor scheduling and memory partitioning for a virtual machine 332 executing on the virtualization server 301. The hypervisor 302 may include those manufactured by VMWare, Inc., of Palo Alto, Calif.; the XENPROJECT hypervisor, an open source product whose development is overseen by the open source XenProject.org community; HyperV, VirtualServer or virtual PC hypervisors provided by Microsoft, or others. The virtualization server 301 may execute a hypervisor 302 that creates a virtual machine platform on which guest operating systems may execute. The virtualization server 301 may be referred to as a host server. An example of such a virtualization server is the XENSERVER provided by Citrix Systems, Inc., of Fort Lauderdale, Fla.

The hypervisor 302 may create one or more virtual machines 332B-C (generally 332) in which guest operating systems 330 execute. The hypervisor 302 may load a virtual machine image to create a virtual machine 332. Additionally or alternatively, the hypervisor 302 may execute a guest operating system 330 within virtual machine 332. Additionally or alternatively, the virtual machine 332 may execute the guest operating system 330.

In addition to creating the virtual machines 332, hypervisor 302 may control the execution of one or more virtual machines 332. The hypervisor 302 may present the one or more virtual machines 332 with an abstraction of one or more hardware resources provided by the virtualization server 301 (e.g., any hardware resource available within the hardware layer 310). The hypervisor 302 may control the manner in which the virtual machines 332 access the physical processors 308 available in the virtualization server 301. Controlling access to the physical processors 308 may include determining whether the virtual machine 332 should have access to the processor 308, and how physical processor capabilities are presented to the virtual machine 332.

As shown in FIG. 3, the virtualization server 301 may host or execute one or more virtual machines 332. A virtual machine 332 is a set of executable instructions that, when executed by a processor, may imitate the operation of a physical computer such that the virtual machine 332 can execute programs and processes much like a physical computing device. While FIG. 3 illustrates an embodiment where a virtualization server 301 hosts three of the virtual machines 332, the virtualization server 301 can host any number of virtual machines 332. The hypervisor 302 may provide each virtual machine 332 with a unique virtual view of the physical hardware, memory, processor, and other system resources available to that virtual machine 332. The unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For example, the hypervisor 302 may create one or more unsecure virtual machines and one or more secure virtual machines. The unsecure virtual machines may be prevented from accessing resources, hardware, memory locations, and programs that the secure virtual machines may be permitted to access. Additionally or alternatively, the hypervisor 302 may provide each virtual machine 332 with a similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326 may be a virtualized view of one or more physical disks 304 of the virtualization server 301, or a portion of the one or more physical disks 304 of the virtualization server 301. The virtualized view of the physical disks 304 can be generated, provided, and managed by the hypervisor 302. The hypervisor 302 may provide each virtual machine 332 with a unique view of the physical disks 304. Thus, the virtual disk 326 included in each virtual machine 332 may be unique when compared with the other virtual disks 326.

A virtual processor 328 may be a virtualized view of the one or more physical processors 308 of the virtualization server 301. The virtualized view of the physical processors 308 may be generated, provided, and managed by the hypervisor 302. The virtual processor 328 may have some or all of the same characteristics of one or more physical processors 308. Additionally or alternatively, the virtual processor 328 provides a modified view of the physical processors 308 such that at least some of the characteristics of the virtual processor 328 are different than the characteristics of the corresponding physical processor 308.

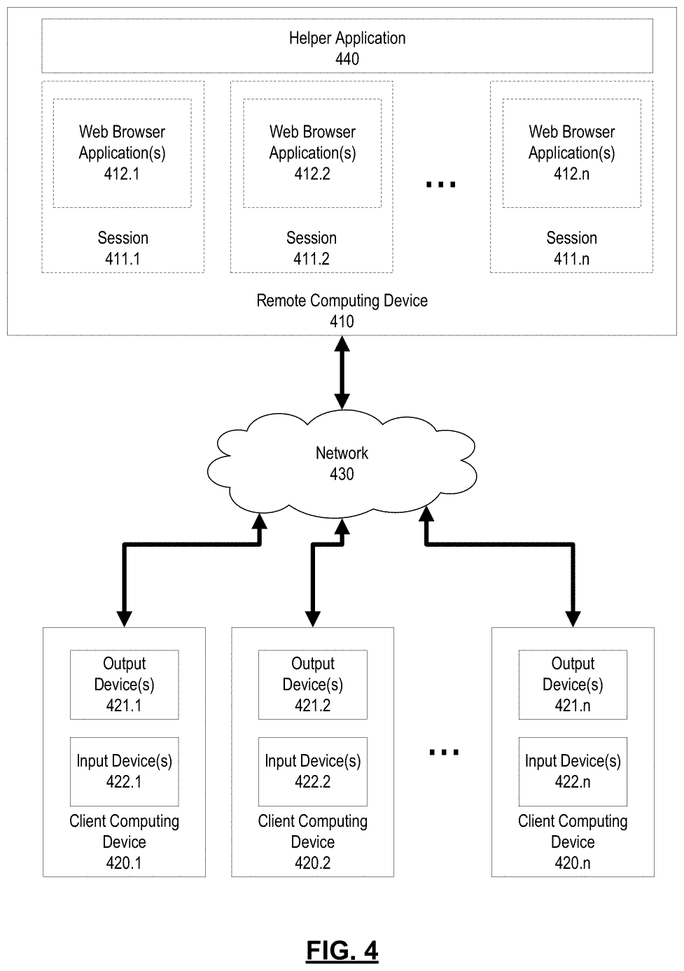

FIG. 4 shows a simplified block diagram of a remote computing device and multiple client computing devices. A remote computing device 410 may comprise one or more sessions 411.1-n and/or a helper application 440. Each session may comprise one or more web browser applications 412.1-n. The remote computing device 410 may be communicatively coupled, e.g., via a network 430, to one or more client computing devices 420.1-n. Each client computing device may be associated with one or more output devices 421.1-n and one or more input devices 422.1-n. The remote computing device 410 may be all, multiple of, or portions of virtualization server 301, data server 103, web server 105, and/or servers 206. The sessions may be all, multiple of, or portions of the virtual machines 332A-C. The client computing devices 420.1-n may be all, multiple of, or portions of client computers 107, 109 and/or client computing devices 240. The remote computing device 410 and the client computing devices 420.1-n may be connected via a network 430, which may be all, multiples of, or portions of the WAN 101, the LAN 225, the WAN 229, the computer network 230, or the like. Though the sessions 411.1-n, web browser applications 412.1-n, client computing devices 420.1-n, displays 421.1-n, and input devices 422.1-n are displayed as plural, any element depicted in FIG. 3 may be singular or plural.

The remote computing device 410 may be configured to manage one or more sessions 411.1-n. The sessions may be the same or similar to the virtual machines 332A-C. A session may comprise one or more applications, such as the web browser applications 412.1-n. The applications may execute in the session. Each session may be logically separated, such as by being executed by the same server or a plurality of servers, with data corresponding to any given session stored on separate or the same memory as another session. Sessions may execute the same or similar applications. Each session on the remote computing device 410 may be associated with one or more users, such that one user may have access to a first set of sessions, whereas another user may have access to a second and different set of sessions. The sessions 411.1-n may be secured. For example, for particularly high security applications, a session may be encrypted and sent to a client computing device for decryption. Sessions may be created or destroyed by the remote computing device 410. For example, in response to a new client computing device connecting to and/or being authenticated by the remote computing device, a new session may be instantiated. As another example, in response to a logoff event associated with a particular session, the particular session may be destroyed.

Applications, such as the web browser applications 412.1-n, may be any computer applications configured to execute on the remote computing device 410. For example, the web browser applications 412.1-n may be conventional web browser applications configured to execute on conventional personal computers (including the client computing devices 420.1-n) and/or may be specially designed to execute in a session on the remote computing device 410. Applications may be modified to, for example, configure the applications to execute in a session. For example, the web browser applications 412.1-n may be configured to not retain browsing history in order to protect the privacy of users of the session. Each session may be associated with a graphical user interface. For example, each session may comprise a desktop environment wherein the user may be able to launch and/or manage applications.

The web browser applications 412.1-n may be configured to retrieve and display content such as web pages. Web pages may comprise content in a variety of formats, such as HyperText Markup Language (HTML), Cascading Style Sheets (CSS), one or more image, audio, or video files, or the like. Web pages may be retrieved from a web server, such as the web server 105. The web browser applications 412.1-n may be configured to retrieve such content and process the content, such as processing the content for display and/or to remove undesirable content (e.g., advertisements, unsecure elements). The web browser may then be configured to provide output associated with the content, such as a display of the content of a web page. For example, the web page may comprise HTML and CSS content, such that the remote computing device 410 may first process the HTML in view of the CSS design preferences, and then display the output in a web browser application. The content displayed may have one or more links, which may be associated with different content. For example, a link in a web page may be associated with a different web page, a video file, or the like. A link may comprise an indication of how the second content should be accessed. For example, a link may indicate that second content is to be opened in a new tab, is to be opened in a particular application or session, or the like.

The remote computing device 410 may be configured to capture output associated with applications executed in a session. Output may comprise any output associated with an application, including graphical output (e.g., an application window and/or an associated Graphical User Interface (GUI)), textual output (e.g., textual console output), audio output (e.g., voice assistant feedback), or the like. The output may be captured such that multiple applications in a single session may produce a single output. For example, output may comprise a video stream comprising multiple applications running simultaneously. As another example, output may comprise an image depicting a web page executing on a web browser application in a session on the remote computing device 410.

The client computing devices 420.1-n may be configured to send input to and receive output from the remote computing device 410. Output may be presented on output devices 421.1-n, and the input sent to the remote computing device 410 may be acquired from input devices 422.1-n. The output devices 421.1-n may comprise, for example, display devices such as computer monitors, audio devices such as speakers, or the like. The input devices 422.1-n may comprise, for example, keyboards, computer mice, touch-sensitive screens, or the like. As with the requests for a new web page or other commands, the input and output may be transmitted via one or more second computing devices, such as a proxy. Output and input may be transmitted using different portions of a network (e.g., the network 430) and/or using different protocols. For example, URL requests may be transmitted via the Hypertext Transfer Protocol (HTTP) and/or the WebSocket protocol, whereas mouse movement data may be transmitted using a proprietary protocol.

The remote computing device 410 may communicate with the client computing devices 420.1-n over the network 430. The manner in which the remote computing device 410 and the client computing devices 420.1-n communicate may depend on the nature of, for example, the sessions 411.1-n, the applications executing on the sessions 411.1-n, and/or the client computing devices 420.1-n. For example, one or more second computing devices may be used, such as one or more proxy devices configured to receive commands in a first format and translate the commands into a second format. The remote computing device 410 and the client computing devices 420.1-n may communicate via one or more protocols, such as HTTP. For example, web page content may be transmitted to a client computing device as a video stream and/or as a static image. As another example, audio content may be packetized and sent as discrete audio files.

The remote computing device 410 and the client computing devices 420.1-n may communicate using the WebSocket protocol or a similar communications protocol, such as HTTP. For example, the client computing devices 420.1-n may send a request for a new tab in an existing session by sending, to the remote computing device 410, an HTTP and/or WebSocket request for a URL comprising an indication of a session (e.g., “www.website.com/?remotesession=2”). As such, the client computing devices 420.1-n need not be configured to know that a tab is requested in a new session or an existing session, or even that a session is opened at all. Similarly, a URL or other communications method may be used to indicate that a website should be opened in a remote session (e.g., in the session 411.1) rather than locally (e.g., in software executing on the client computing device 420.1). For example, a user of the client computing device 420.2 may access a URL (e.g., “www.remotecomputingdevice.com/www.website.com/newtab/session2/”) which may be intercepted by the helper application 440 and cause the remote computing device 410 to open a website (e.g., “www.website.com”) in a new tab in a particular session (e.g. the session 411.2).

The helper application 440 may be a program executing on all or portions of the remote computing device 410 configured to receive all or portions of communications from the client computing devices 4201-n and implement the communications with respect to the sessions 411.1-n. As an example, the helper application 440 may be an Application Programming Interface (API) associated with all or portions of the virtualization server 301, the hypervisor 302, the operating system 314, the remote computing device 410, or the like. The helper application 440 may be a plurality of applications, each associated with and/or executing in one of the sessions 411.1-n. For example, each session may have a respective helper application with a respective WebSocket channel for receiving instructions. The helper application 440 may be configured to open a channel (e.g., a WebSocket channel) to receive instructions (e.g., instructions to open a new tab) from the client computing devices 420.1-n. Based on such instructions, the helper application 440 may open a new tab in the web browser applications 412.1-n. Implementing the communications may comprise receiving an indication of one session of the sessions 411.1-n. For example, the helper application 440 may receive, from the client computing device 420.1, a communication comprising an indication of a website and an indication of a session ID (e.g., “www.website.com/newtab/session/1”) from the client computing device 420.1, determine the portion of the communication corresponding to an indication of a session (e.g., “/session/1”), determine a particular session (e.g., session 411.1) corresponding to the indication, and cause the website (e.g., “www.website.com”) to be opened in a new tab in that session.

The helper application 440 may be configured to handle multiple protocols used by any of the client computing devices 420.1-n, the remote computing device 410, and/or the sessions 411.1-n. For example, the helper application 440 may receive commands from the client computing devices 420.1-n via HTTP, determine that those commands request a website in a new tab in a particular session, and, using the WebSocket protocol, instruct the particular session to open the website in a new tab. One or more additional computing devices and/or services may be involved with the helper application 440. For example, a service for receiving all input from the client computing devices 420.1-n may receive the input and only transmit the HTTP requests indicating a request for a new tab to the helper application 440.

The helper application 440 may be executed on one or more second remote computing devices different from the remote computing device 410. The helper application 440 may comprise an external service that maintains information about sessions (e.g., those executing on the remote computing device 410) and is configured to receive all or portions of communications from the client computing devices 420.1-n and implement the communications with respect to the sessions 411.1-n. The helper application 440 may comprise a proxy. For example, one or more second remote computing devices may receive commands from any other computing devices via a first protocol (e.g., via HTTP or WebSocket), determine one or more sessions executing on the remote computing device 410 that the commands correspond to, and cause the commands to execute with the determined one or more sessions via the same or a different protocol. As such, as described herein, requests transmitted from the client computing devices 420.1-n and for the remote computing device 410 may be transmitted via the one or more second remote computing devices, which may be configured to interpret and cause the requests to execute with respect to the remote computing device. For example, the client computing devices 420.1-n may be configured to transmit a request for a new web page to the one or more second computing devices via a first protocol (e.g., HTTP), and the one or more second computing devices may determine that the new web page should be opened in a new tab in an existing session and transmit an instruction to one of the sessions 411.1-n to open the new web page in a new tab via a second protocol (e.g., WebSocket).

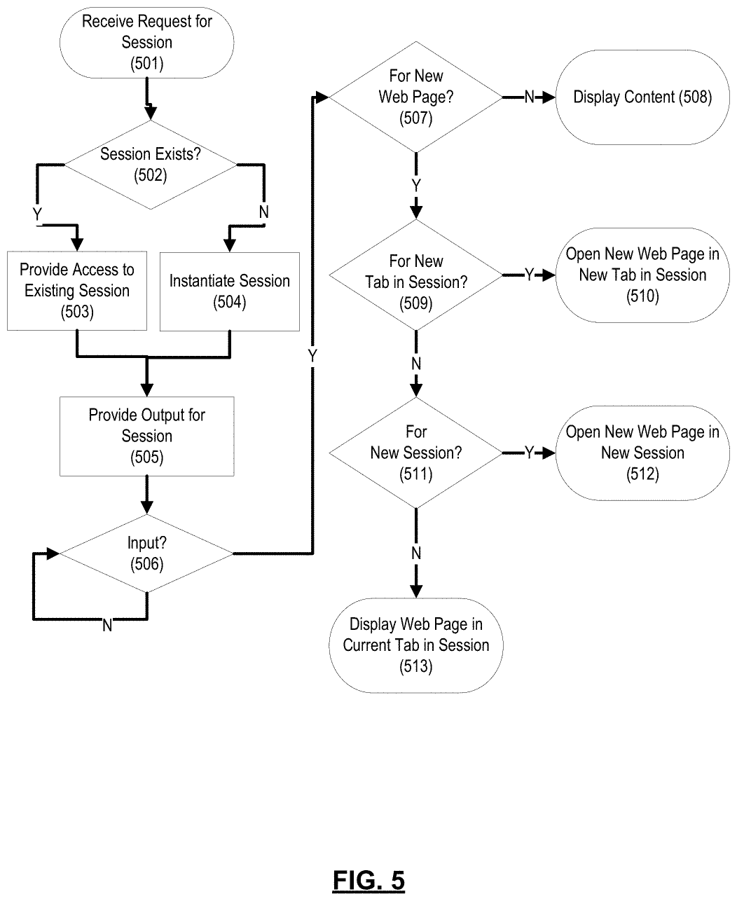

FIG. 5 is a flow chart depicting steps which may be taken by the remote computing device 410. In step 501, the remote computing device 410 may receive, from a client computing device, a request for a session. The request may, but need not, comprise an indication of a web page and/or the desire that the web page be opened in a new tab. The request may comprise a request to begin a default session, a request to open one or more particular applications in a particular session, to access an existing session on the remote computing device 410, or the like. For example, a request for a session may comprise a request, from a client computing device, for access to a particular web application, and the remote computing device 410 may determine that the web application should be opened in a session. The user of a client computing device need not know that a particular action comprises a request for a session. For example, the distinction between local programs (e.g., those executed on a client computing device) and remote programs (e.g., those executed on the remote computing device 410) may be hidden to the user and/or available via the same or a similar interface.

In step 502, the remote computing device 410 may determine whether a session corresponding to the request exists. A session corresponding to the request may exist if the request is associated with an existing session. For example, a user of a laptop computer may request to access a session they previously accessed on a desktop computer. As another example, the remote computing device 410 may maintain a number of permanent sessions, and the request may be associated with an application executing in a permanent session. A list of sessions may be maintained in a database (e.g., in all or a portion of the helper application 440), and the database may be queried to determine whether a session corresponding to the request exists. The request may comprise a request for a new session and/or may not be associated with an existing session, causing the remote computing device 410 to determine that a new session should be instantiated. For example, a user may request an existing session, but the session may have expired, such that the remote computing device 410 may determine to instantiate a new session for the user. If a session corresponding to the request exists, access to the existing session may be provided in step 503. Otherwise, a new session may be instantiated in step 504. Instantiating a session in step 504 may comprise any steps which may create a new session such as, for example, using a hypervisor (e.g. hypervisor 302) to create a virtual machine. Whether existing or new, as used herein, this session may be referred to as a current session.

In step 505, the remote computing device 410 may provide output associated with the current session. The output may be to the same client computing device from which the request for the session was received in step 501, or may be a different client computing device. For example, the request for the session may have been made from a smartphone, but the output from the current session may be sent to a personal computer.

In step 506, the remote computing device 410 may wait for input from a client computing device. The input may comprise commands associated with a displayed web page, such as clicking on a link, moving a mouse, sending voice data from a microphone, or the like. The input may be received from the input devices 422.1-n. The input may be via a session, such as an interaction with a website currently displayed in a web browser of a current session. Additionally or alternative, the input may be via software executing on a client computing device outside of the session or via another computing device. Input may comprise commands received from a web page, such as a command to access a new web page prompted from a JavaScript application in a web page. The input may comprise a request for a new webpage. The request may comprise an indication of the new web page, such as a Uniform Resource Locator (URL) of the web page. Input need not relate to opening a new web page, but may interact with a currently-displayed web page in the current session. If input is not received, the remote computing device may continue to wait for input. The input may be received from the same client computing device accessing the current session, from a different computing device, or from a different session. For example, input in one session may cause another session to request that it open a new web page in a new tab. If input is received, the flow chart proceeds to step 507.

The client computing device may transmit the request via one of a plurality of applications. The request may originate from an application different from a display application used to display output from the remote computing device 410. For example, the client computing device may comprise a menu application and a display application. The menu application may be configured to transmit requests for a web page to the remote computing device 410, and may do so without regard to the output of the remote computing device 410. The menu application may, for example, comprise a plurality of icons to web pages of interest, and the menu application may be configured to receive a user selection of one of the plurality of icons. The display application may be configured to display output from the remote computing device 410 and receive input from the client computing device. In this manner, while the display application may allow a user to interact with a web page in a conventional manner, the menu application may provide the user the ability to easily open a new web page in a new tab in the display application without interacting with the display application. The menu application may execute on a different client computing device than the display application. For example, the display application may execute on a personal computer, whereas the menu application may execute on a smartphone.

The request may be received via a proxy, which may determine that the request be performed in a session on the remote computing device 410. A user of a client computing device may browse a first web page (e.g., via a web browser executing on the client computing device and/or a web browser executing in a session of the remote computing device 410) and request a second web page. The proxy may receive the request for the second web page and, based on the request, translate the request into a request for the second web page in a new tab in a new or existing session on the remote computing device 410. As an example, a user of a client computing device may browse a trusted web page (e.g., a web page associated with a trusted corporate intranet) on a browser executing directly on the client computing device, and may click a link on the trusted web page that leads to an untrusted web page (e.g., a web page outside the trusted corporate intranet). A proxy (e.g., an HTTP proxy) may receive the request for the untrusted web page and transmit the request to be opened in a new tab in a new or existing session. In this manner, untrusted web pages may be opened in a new session, where security may be better controlled. The proxy may be all or portions of the remote computing device 410 and/or the one or more second computing devices described above. The proxy may be configured to store a list of web pages (e.g., trusted or untrusted web pages), and may compare a received request to the list to determine whether the web page should be opened in a new tab in a current or existing session.

In step 507, the remote computing device 410 may determine whether the input is associated with a request for a new web page. A new web page need not be different from web pages currently open in a web browser application. For example, a user may desire to open multiple copies of the exact same web page, and thus the request for the new web page may be for the same page already opened in an existing tab of a web browser application. The request may comprise clicking a link on another website, a request via an application executing on a client computing device (e.g., an “Open About Page” option in an application menu), or the like. If the request is not associated with a new webpage, the flow chart may proceed to step 508, where it may display content (e.g., a response to the input). If the request is associated with a new webpage, the flow chart may proceed to step 509.

Input, such as that in step 507, may be handled by one or more computing devices and/or processes. For example, a service may store information associated with active sessions and may transmit input from a client computing device to an appropriate session. The service may be configured to translate commands for use by the session and/or applications executing in the session. For example, a user may request a URL open in a new tab in a session by sending only the URL to the service, which may then process the URL and use it to instruct a web browser in the session to open a new tab and load the URL.

In step 509, the remote computing device 410 may determine whether the request is for a new web page in a new tab in the current session. The request may indicate that the new web page should be opened in a new tab. For example, a web page designer may prefer that certain pages open new tabs rather than new web browser application windows, and a link may indicate that a particular web page is to be opened in a new tab. The request as transmitted from a client computing device may not indicate that the new web page is to be opened in a new tab, but a proxy may receive the request and add an indication to the request that the web page should be opened in a new tab. A request for a web page in a new tab need not originate from a web page currently being displayed in the session. For example, a user may select a menu option in a menu application executing on a client computing device, which may trigger a request for a web page in a new tab in an existing web browser instance. If the request is for a new tab, the flow chart may proceed to step 510. Otherwise, it may proceed to step 511.

In step 510, the remote computing device 410 may cause a new tab displaying the requested web page to display in the session from step 503 or 504. The remote computing device 410 may cause an application in the session to open the new tab via a web browser application, or may send the instruction directly to the web browser application. Causing an application in the session to open a new tab may comprise, for example, executing all or portions of a helper application (e.g., the helper application 440) in the session. For example, a particular web browser with tab functionality in a session may not be directly instructed to open a new tab, so a helper application in the session may execute particular keystrokes to cause the web browser to open a new tab.

In step 511, the remote computing device 410 may determine whether the request is for a new session. A request may indicate that a web page should be opened in a new session, rather than the current session. Opening a web page in a new session may be desirable to quarantine certain websites, e.g., such that personal websites are separated from business websites. If the request is for a new session, in step 512, the remote computing device 410 may instantiate a new session and cause the web page to be opened in the new session.

If the request is for neither a new tab nor a new session, in step 513, the remote computing device 410 may display the new web page in the existing tab in the current session. The request for the new web page may comprise an indication of a particular tab to open the new web page in. For example, the request may indicate that a third tab, formerly presenting a third website, should now present a fourth website.

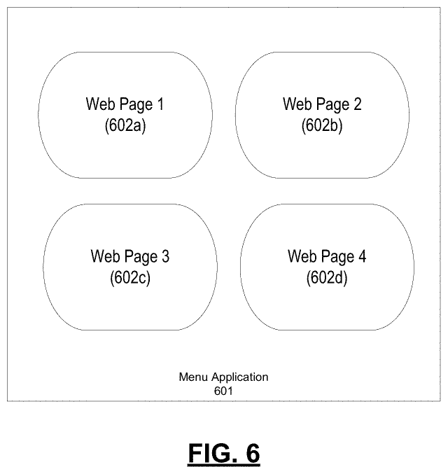

FIG. 6 depicts an example menu application. A menu application 601 may be configured to transmit requests for a web page to the remote computing device 410, and may do so without regard to the output of the remote computing device 410. The menu application 601 may include a plurality of web page links, such as web page links 602a-d. The menu application may be, for example, an application executing on a smartphone, a web page, or the like. The menu application may simplify the process of opening a new tab in a new or existing session. For example, a user may currently execute both a display application and the menu application 601 on a client computing device. The display application may be on a first display, the menu application 601 may be on a second display. The user may be using the display application to browse a first web page using the remote computing device 410, but decide to open a second tab with a second web page. The user may click a web page link (e.g., the web page link 602b) on the menu application 601, which may send a request to the remote computing device 410 to open a new tab and load the second web page in the new tab.

The web page links (e.g., the web page link 602b) may be formatted to transmit session information and/or an indication that a new tab is requested in a given session. For example, to open a URL (e.g., “www.website.com/page/”) on a web browser in a new tab in a current session (e.g., a session with an ID of 42), the web page links depicted in the menu application 601 may be formatted to transmit both a URL and an indication of the session ID inside a URL (e.g., “www.website.com/page/newtab/session42”). Such a URL may be transmitted to the remote computing device 410, including to the helper application 440, which may extract a portion of the URL corresponding to the session. As such, the client computing devices 420.1-n may be configured to request new tabs in an existing session using conventional protocols (e.g., HTTP, WebSocket).

One or more aspects of the disclosure may be embodied in a computer-usable media and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (“FPGA”), and the like. Particular data structures may be used to more effectively implement one or more aspects of the disclosure, and such data structures are contemplated within the scope of computer executable instructions and computer-usable data described herein.

Aspects of the disclosure have been described in terms of examples. While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned examples may be utilized alone or in combination or sub-combination with elements of the other examples. For example, any of the above described systems and methods or parts thereof may be combined with the other methods and systems or parts thereof described above. For example, the steps shown in the figures may be performed in other than the recited order, and one or more steps shown may be optional in accordance with aspects of the disclosure. It will also be appreciated and understood that modifications may be made without departing from the true spirit and scope of the present disclosure. The description is thus to be regarded as illustrative instead of restrictive on the present disclosure.

We claim:

1. A method comprising:
receiving, by a remote computing device and from a client computing device, a first indication of a first web page;
instantiating a session on the remote computing device, wherein the session comprises an instance of a web browser, and wherein the instance of the web browser is configured to display the first web page in a first tab;
sending, to the client computing device, first output associated with the first tab, wherein the first output is configured to be displayed by a display application;
receiving, from a second application different from the display application, a second indication of a second web page;
causing, in the session and based on receiving the second indication, display of the second web page in a second tab of the web browser; and
sending, to the client computing device, second output associated with the second tab.

2. The method of claim 1, further comprising:
receiving, from the client computing device and via the second application, a third indication of a third web page, wherein the third indication comprises a request for a new session; and
instantiating, based on the third indication, the new session, wherein the new session comprises a second instance of the web browser, and wherein the second instance of the web browser is configured to display the third web page.

3. The method of claim 1, further comprising:
receiving, from the client computing device and via the second application, a third indication of a third web page, wherein the third indication comprises a fourth indication of a particular tab of the web browser; and
causing display of the third web page in the particular tab.

4. The method of claim 1, wherein the second application executes on a second client computing device or a second session on the remote computing device.

5. The method of claim 1, wherein the second indication of the second web page is received via a proxy, and wherein the proxy is configured to receive the second indication from the second application and transmit the second indication of the second web page to the remote computing device.

6. The method of claim 1, wherein the second application comprises a plurality of indications of a plurality of web pages, and wherein receiving the first indication of the first web page is responsive to a user selection of the first indication from the plurality of indications.

7. The method of claim 1, further comprising:
receiving, from the client computing device, an indication of the first tab; and
sending, to the client computing device, output associated with the first tab.

8. The method of claim 1, wherein the session comprises a helper application configured to receive the second indication for the second web page, wherein the helper application causes the web browser to open the second web page in the second tab.

9. The method of claim 1, wherein the first indication and the second indication are received via Hypertext Transfer Protocol (HTTP).

10. An apparatus comprising:
one or more processors; and
memory storing instructions that, when executed by the one or more processors, cause the apparatus to:
receive, from a client computing device, a first indication of a first web page;
instantiate a session, wherein the session comprises an instance of a web browser, and wherein the instance of the web browser is configured to display the first web page in a first tab;
send, to the client computing device, first output associated with the first tab, wherein the first output is configured to be displayed by a display application;
receive, from a second application different from the display application, a second indication of a second web page;
cause, in the session and based on receiving the second indication, display of the second web page in a second tab of the web browser; and
send, to the client computing device, second output associated with the second tab.

11. The apparatus of claim 10, wherein the instructions, when executed by the one or more processors, further cause the apparatus to:
receive, from the client computing device and via the second application, a third indication of a third web page, wherein the third indication comprises a request for a new session; and
instantiate, based on the third indication, the new session, wherein the new session comprises a second instance of the web browser, and wherein the second instance of the web browser is configured to display the third web page.

12. The apparatus of claim 10, wherein the instructions, when executed by the one or more processors, further cause the apparatus to:
receive, from the client computing device and via the second application, a third indication of a third web page, wherein the third indication comprises a fourth indication of a particular tab of the web browser; and
cause display of the third web page in the particular tab.

13. The apparatus of claim 10, wherein the second application executes on a second client computing device.

14. The apparatus of claim 10, wherein the second application executes on a second session on the apparatus.

15. The apparatus of claim 10, wherein the second application comprises a plurality of indications of a plurality of web pages, and wherein receiving the first indication of the first web page is responsive to a user selection of the first indication from the plurality of indications.

16. A system comprising:
a remote computing device; and
a client computing device;
wherein the client computing device is configured to:
transmit, to the remote computing device and via a menu application, an indication of a first indication of a first web page; and
transmit, to the remote computing device and via the menu application, a second indication of a second web page;
wherein the remote computing device is configured to:
receive the first indication;
instantiate a session, wherein the session comprises an instance of a web browser, and wherein the instance of the web browser is configured to display the first web page in a first tab;
send, to the client computing device, first output associated with the first tab, wherein the first output is configured to be displayed by a display application different from the menu application;
receive the second indication;
cause, in the session and based on receiving the second indication, display of the second web page in a second tab of the web browser; and
send, to the client computing device, second output associated with the second tab.

17. The system of claim 16, wherein the remote computing device is further configured to:
receive, from the client computing device and via the menu application, a third indication of a third web page, wherein the third indication comprises a request for a new session; and
instantiate, based on the third indication, the new session, wherein the new session comprises a second instance of the web browser, and wherein the second instance of the web browser is configured to display the third web page.

18. The system of claim 16, wherein the remote computing device is further configured to:
receive, from the client computing device and via the menu application, a third indication of a third web page, wherein the third indication comprises a fourth indication of a particular tab of the web browser; and
cause display of the third web page in the particular tab.

19. The system of claim 16, wherein the menu application executes on a second client computing device.

20. The system of claim 16, wherein the menu application executes on a second session on the remote computing device.
